(19) United States
(12) Patent Application Publication
(10) Pub. No.: US 2018/0335302 A1
(43) Pub. Date: Nov. 22, 2018

(54) SCANNING DEVICE AND SCANNING SYSTEM FOR WAFER POLISHING APPARATUS

(71) Applicant: SK SILTRON CO., LTD., Gumi-si, Gyeongsangbuk-do (KR)

(72) Inventor: Suk Jin JUNG, Gumi-si (KR)

(21) Appl. No.: 15/559,649

(22) PCT Filed: Jul. 3, 2015
(86) PCT No.: PCT/KR2015/006875

§ 371 Date: Sep. 19, 2017

(30) Foreign Application Priority Data
Jun. 24, 2015 (KR) 10-2015-0089467

(51) Int. Cl. G01B 11/30; B24B 37/005

(52) U.S. Cl. CPC G01B 11/303; G01B 11/306; B24B 37/005

(57) ABSTRACT

An embodiment of a scanning device may comprises: a guide frame; a moving part which moves along the longitudinal direction of the guide frame; a bracket, one side of which is coupled to the moving part; a sensing unit which is coupled to the other side of the bracket and senses the surface state of an object placed in the vertical direction perpendicular to the longitudinal direction of the guide frame; and a pair of support parts which are coupled to both sides of the guide frame.

### TECHNICAL FIELD

Embodiments relate to a scanning device and a scanning system for a wafer polishing apparatus.

### BACKGROUND ART

The matters described as the background art have been provided only to provide background information regarding embodiments and should not be construed as acknowledging them as the related art.

Recently, the high integration of semiconductors has increased the information processing and storage capacity per unit area, but requires an increase in the diameter of semiconductor wafers, a reduction in the width of circuit lines, and multilayered wiring. In order to form multilayered wires on a semiconductor wafer, a planarization process needs to be performed after each layer of wire is formed.

One such wafer planarization process is a wafer polishing process. A wafer polishing process is a process of polishing the upper and lower surfaces of a wafer using polishing pads.

However, as the wafer polishing process is successively and repeatedly performed, for example, wear and deterioration in the performance of the polishing pad may occur. When wear and deterioration in the performance of the polishing pad occurs, the wafer may be damaged during the polishing process.

Therefore, it is necessary to periodically flatten or replace the polishing pad, and in order to determine whether to flatten or replace the polishing pad, the state of the surfaces of the polishing pad needs to be checked. Accordingly, there is a demand for the development of a device that is capable of rapidly and accurately measuring the state of the surface of the polishing pad.

### TECHNICAL OBJECT

Accordingly, embodiments related to a scanning device and a scanning system for a wafer polishing apparatus, which enable the rapid and accurate measurement of the state of the surface of a polishing pad.

The technical objects of the embodiments are not limited to the technical object as mentioned above, and other unmentioned technical objects will be clearly understood by those skilled in the art from the following description.

### TECHNICAL SOLUTION

To achieve the objects described above, one embodiment provides a scanning device including a guide frame, a moving unit configured to move in a longitudinal direction of the guide frame, a bracket coupled at one side thereof to the moving unit, a sensing unit coupled to a remaining side of the bracket and configured to sense a surface state of an object disposed in a vertical direction that is orthogonal to the longitudinal direction of the guide frame, and a pair of support units coupled to opposite sides of the guide frame.

Another embodiment provides a scanning device including a guide frame having a recess formed in a longitudinal direction thereof and magnets disposed respectively above and under the recess, a moving unit having a protrusion configured to be inserted into the recess and a coil disposed inside the protrusion to receive electric power, the moving unit being configured to move in the longitudinal direction of the guide frame, a bracket coupled at one side thereof to the moving unit, a sensing unit coupled to a remaining side of the bracket and configured to sense a surface state of an object disposed in a vertical direction that is orthogonal to the longitudinal direction of the guide frame, and a pair of support units coupled to opposite sides of the guide frame.

A further embodiment provides a scanning system including a guide frame, a moving unit configured to move in a longitudinal direction of the guide frame, a bracket coupled at one side thereof to the moving unit, a sensing unit coupled to a remaining side of the bracket and configured to sense a surface state of an object disposed in a vertical direction that is orthogonal to the longitudinal direction of the guide frame, a pair of support units coupled to opposite sides of the guide frame, a control unit electrically connected to the moving unit and the sensing unit, and an external power supply configured to supply electric power to the control unit.

### ADVANTAGEOUS EFFECTS

In the embodiments, because the sensing unit may simultaneously sense the state of the surfaces of both a first polishing pad a second polishing pad, the scanning speed of the polishing apparatus may be increased and the scanning time may be remarkably reduced.

In addition, when the sensing unit emits a circularly polarized laser to the first polishing pad or the second polishing pad using a quarter-wave plate, measured data may exhibit remarkably reduced noise. Therefore, the scanning device may more accurately detect the state of the surfaces of the first polishing pad and the second polishing pad.

In addition, because the scanning device and the scanning system may scan the polishing apparatus in a non-contact manner, little vibration and friction may occur compared to a contact manner, and consequently, accurate data on the state of the surface of the polishing apparatus may be collected.

### DESCRIPTION OF DRAWINGS

FIG. 1 is a perspective view illustrating a scanning device according to an embodiment.

FIG. 2 is a front view illustrating the scanning device according to the embodiment.

FIG. 3 is a plan view illustrating the scanning device according to the embodiment.

FIG. 4 is a schematic view illustrating a portion of the scanning device according to the embodiment.

FIG. 5 is a plan view illustrating portion A of FIG. 4.

FIG. 6 is a view taken along line Z-Z of FIG. 3.

FIG. 7 is an enlarged view illustrating portion B of FIG. 6.

FIG. 8 is a view for explaining variation in the characteristics of light that passes through a polarizer plate and a quarter-wave plate provided in the scanning device according to the embodiment.

FIG. 9 is a graph for explaining the characteristics of a scanned data signal when the scanning device has no quarter-wave plate.

FIG. 10 is a graph for explaining the characteristics of a scanned data signal when the scanning device has a quarter-wave plate.

FIG. 11 is a view for explaining a scanning system according to an embodiment.

### BEST MODE

Hereinafter, embodiments will be described in detail with reference to the accompanying drawings. The embodiments may be modified in various ways and may have various forms, and specific embodiments will be illustrated in the drawings and will be described in detail herein. However, it should be understood that such illustration and description are not intended to limit the embodiments to the specific described forms and include all modifications, equivalents and substitutions that fall within the sprit and technical range of the embodiments. In this process, the sizes, shapes, and the like of elements illustrated in the drawings may be exaggerated for clarity and convenience of description.

Although terms such as, for example, “first” and “second” may be used to describe various elements, the embodiments should not be limited by these terms. The terms are used only to distinguish any one element from another element. In addition, the terms, which are specially defined taking into consideration the configurations and operations of the embodiments, are merely provided to describe the embodiments and are not intended to limit the scope of the present invention.

In the description of the embodiments, It will be understood that, when an element such as a layer (film), region, pattern or structure is referred to as being formed “on” or “under” another element, such as a substrate, layer (film), region, pad or pattern, it can be directly “on” or “under” the other element or be indirectly formed with intervening elements therebetween. It will also be understood that “on” or “under” the element may be described relative to the drawings.

In addition, relative terms such as, for example, “on/upper/above” and “beneath/lower/below”, used in the following description may be used to distinguish any one substance or element with another substance or element without requiring or containing any physical or logical relationship or sequence between these substances or elements. In addition, in the drawings, a Cartesian coordinate system (x, y, z) may be used.

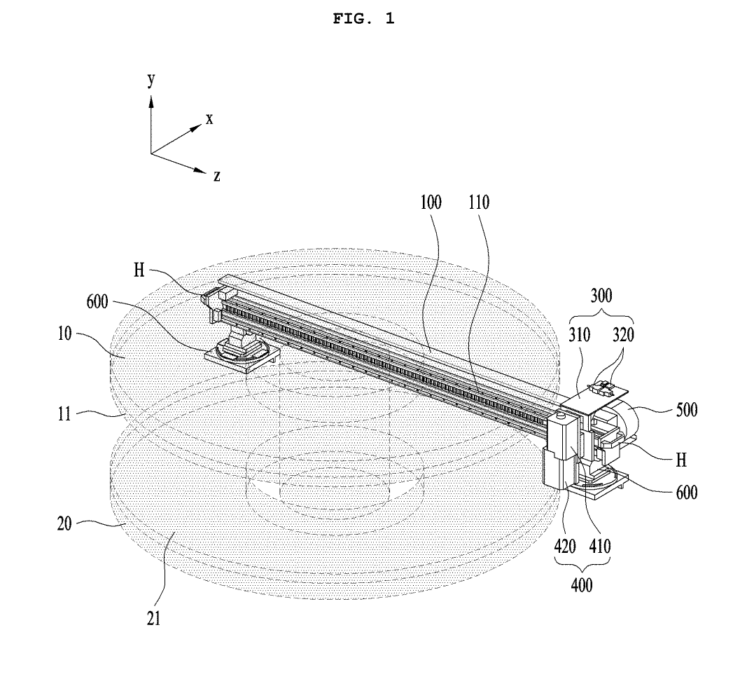

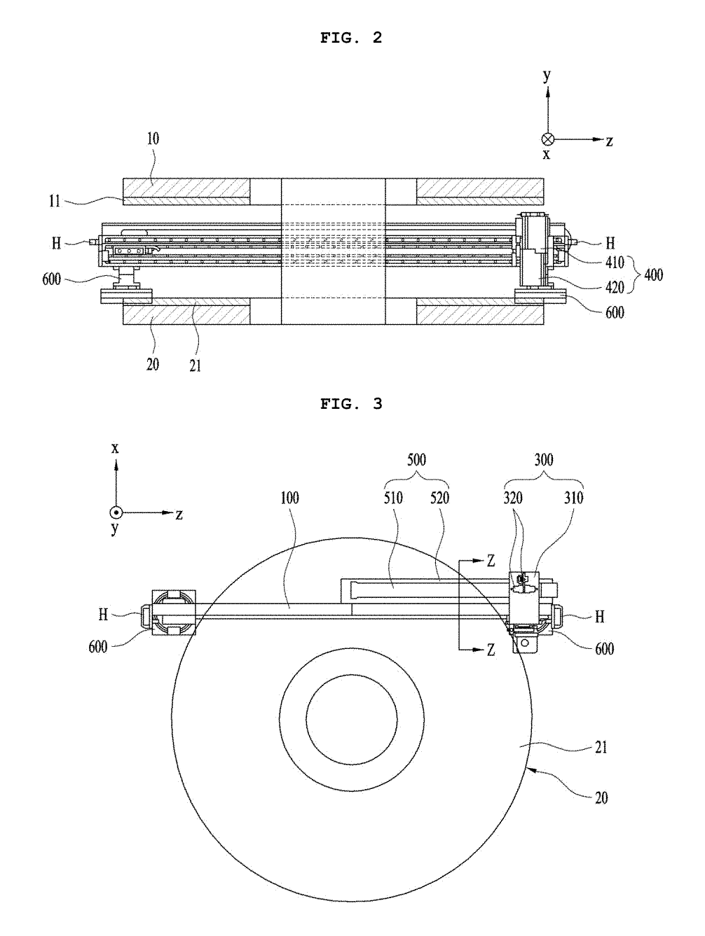

FIG. 1 is a perspective view illustrating a scanning device according to an embodiment. FIG. 2 is a front view illustrating the scanning device according to the embodiment. FIG. 3 is a plan view illustrating the scanning device according to the embodiment. The scanning device may serve to scan a wafer polishing apparatus. The wafer polishing apparatus will first be described.

The wafer polishing apparatus may include an upper plate 10, a first polishing pad 11, a lower plate 20, and a second polishing pad 21. The upper plate 10 and the lower plate 20 may be provided so as to be rotated by a drive device (not illustrated). The first polishing pad 11 may be attached to the lower surface of the upper plate 10, and the second polishing pad 21 may be attached to the upper surface of the lower plate 20.

A wafer (not illustrated) is disposed between the first polishing pad 11 and the second polishing pad 21. After the first polishing pad 11 and the second polishing pad 21 are brought into contact with the upper surface and the lower surface of the wafer respectively by adjusting the heights of the upper plate 10 and the lower plate 20, the upper plate 10 and the lower plate 20 may be rotated to enable polishing of the surfaces of the wafer.

The first polishing pad 11 and the second polishing pad 21 may be formed of, for example, a non-woven polishing fabric. Meanwhile, when the first polishing pad 11 and the second polishing pad 21 are successively and repeatedly used to smoothen the wafer, the first polishing pad 11 and the second polishing pad 21 may undergo, for example, wear, thus being deteriorated in polishing performance.

Therefore, the scanning device of the embodiment may measure the surface states of the first polishing pad 11 and the second polishing pad 21 in a non-contact manner. Specifically, the scanning device may measure the surface states of the first polishing pad 11 and the second polishing pad 21 by scanning the waviness or surface roughness of the first polishing pad 11 and the second polishing pad 21.

When the measured surface states of the first polishing pad 11 and the second polishing pad 21 are at a level that causes, for example, deterioration in the performance of the polishing apparatus or damage to the wafer, dressing may be performed to remove foreign substances from the surfaces of the first polishing pad 11 and the second polishing pad 21 and to smoothen the surfaces of the first polishing pad 11 and the second polishing pad 21. In addition, when the first polishing pad 11 and the second polishing pad 21 are seriously worn or the degree of wear exceeds a predetermined reference value, the first polishing pad 11 and the second polishing pad 21 may be replaced.

Therefore, in order to determine whether to perform dressing on the first polishing pad 11 and the second polishing pad 21 or to replace the first polishing pad 11 and the second polishing pad 21, the scanning device of the embodiment may provide information by which the surface states of the first polishing pad 11 and the second polishing pad 21 may be accurately verified.

The scanning device may be disposed between the first polishing pad 11 and the second polishing pad 21, which are vertically opposite each other, to scan the first polishing pad 11 and the second polishing pad 21. Here, the scanning device may include a guide frame 100, a moving unit 200, a bracket 300, a sensing unit 400, a cable-conveyor mechanism 500 having a cable 510, and a support unit 600.

The guide frame 100, as illustrated in FIG. 1, may be upwardly and downwardly spaced apart from the upper plate 10 and the lower plate 20 of the wafer polishing apparatus, respectively, and may also be upwardly and downwardly spaced apart from the first polishing pad 11 and the second polishing pad 21.

Meanwhile, the guide frame 100 may be provided on opposite ends thereof with handles H in order to allow a user to easily move the scanning device as needed.

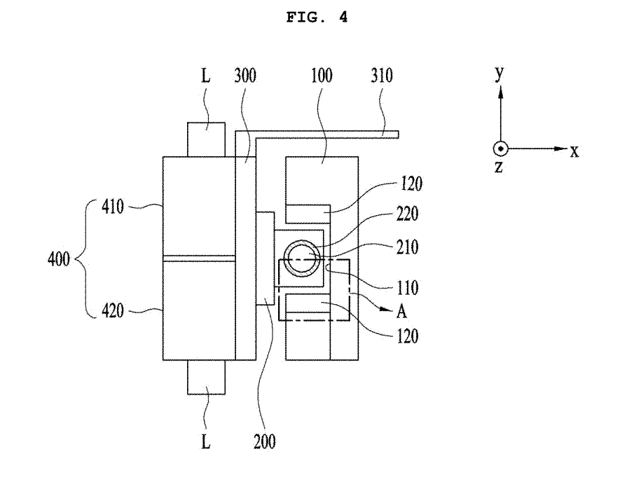

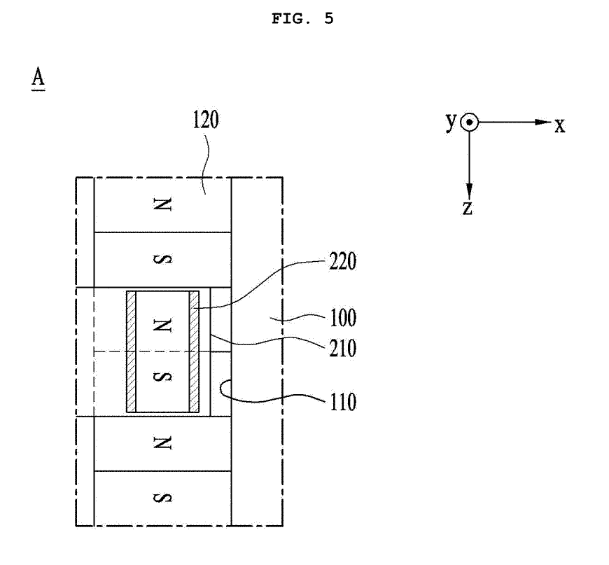

The moving unit 200 may be coupled to the guide frame 100 so as to move in the longitudinal direction of the guide frame 100. The moving unit 200 will be described in detail with reference to, for example, FIGS. 4 and 5.

The bracket 300 may be coupled on one side thereof to the moving unit 200 and on the other side thereof to the sensing unit 400. That is, the bracket 300 may couple the sensing unit 200 to the moving unit 200 so as to allow the sensing unit 400 to move along with the moving unit 200 in the longitudinal direction of the guide frame 100.

The bracket 300 may include a bent portion 310, which is formed by laterally bending an upper portion of the bracket 300 in a direction orthogonal to the longitudinal direction of the guide frame 100. Here, a connector 320 may be provided on the bent portion 310. The connector 320 may be connected to an external power supply 900, which serves to apply electric power to the moving unit 200 or the sensing unit 400.

Accordingly, one end of the connector 320 may be connected to the cable 510, and the other end may be connected to a control unit 800 and the external power supply 900, which is also connected to the control unit 800. Here, the other end may have a socket structure.

This is because, for easy movement of the scanning device, it is appropriate to allow a wire that interconnects the control unit 800 and the connector 320 to be easily separated from the connector 320.

The sensing unit 400 may be coupled to the other side of the bracket 300 and may serve to sense the surface state of an object that is oriented in the vertical direction, orthogonal to the longitudinal direction of the guide frame 100, i.e. the first polishing pad 11 and the second polishing pad 21.

Here, the sensing unit 400 may be coupled to the moving unit 200 via the bracket 300, and thus may sense the surface state of the first polishing pad 11 and the second polishing pad 21 while moving, along with the moving unit 200, in the longitudinal direction of the guide frame 100.

As described above, the sensing unit 400 may sense the waviness or surface roughness of the first polishing pad 11 and the second polishing pad 21. To this end, the sensing unit may include a first sensor 410 and a second sensor 420. In addition, the sensing unit 400 may include, for example, a laser sensor.

As illustrated in FIG. 1, the first sensor 410 may be provided in the upper region of the sensing unit 400 and may sense the waviness or surface roughness of the first polishing pad 11 by emitting a laser to the first polishing pad 11. The second sensor 420 may be provided in the lower region of the sensing unit 400 and may sense the waviness or surface roughness of the second polishing pad 21 by emitting a laser to the second polishing pad 21.

The cable-conveyor mechanism 500 including the cable 510, as illustrated in FIG. 3, may be disposed in the longitudinal direction of the guide frame 100, and may further include a conveyor 520, in addition to the cable 510. The cable 510 may serve to connect the sensing unit 400 and the moving unit 200, which require electric power, to the external power supply 900. In addition, data measured in the sensing unit 400 may be transmitted to a main controller 830 via the cable 510.

The cable 510 may be formed of a flexible material, and may be connected at one end thereof to the sensing unit 400 and the moving unit 200 and at the other end thereof to the connector 320.

The conveyor 520 may serve to support the cable 510, which is disposed in the longitudinal direction of the guide frame 100. Here, one side of the cable 510 may be coupled to the conveyor 520.

When the moving unit 200 and the sensing unit 400 move in the longitudinal direction of the guide frame 100, the cable 510, which is formed of a flexible material, may be deformed depending on the movement of the moving unit 200 and the sensing unit 400.

That is, the cable 510 may be folded or unfolded. At this time, the conveyor 520 may serve to support the cable 520 so as to prevent the cable from being tangled or drooping downward in the process of being folded or unfolded.

The support unit 600 may be provided in a pair and the pair of support units 600 may be coupled respectively to opposite sides of the guide frame 100, thereby serving to support the guide frame 100. The bottom of the support unit 600 may be disposed on a floor 40 or a support stand 30.

When the polishing apparatus is scanned using the scanning device, as illustrated in FIGS. 1 and 3, the guide frame 100 may be longitudinally disposed in the circular arc direction of the upper plate 10 and the lower plate 20.

Here, the upper plate 10 and the lower plate 20 may have a disc shape, and the lower surface of the upper plate 10 and the upper surface of the lower plate 20 may be disposed to face each other. In addition, the upper plate 10 and the lower plate 20 may be provided so as to rotate relative to the guide frame 100, and may rotate about the respective centers thereof.

Accordingly, the guide frame 100 may be longitudinally disposed in the circular arc direction of the upper plate 10 and the lower plate 20, and the sensing unit 400 may sense the waviness or surface roughness of the first polishing pad 11 and the second polishing pad 21, which are attached to the upper plate 10 and the lower plate 20, while moving in the longitudinal direction of the guide frame 100.

Accordingly, in the embodiment, because the sensing unit 400 may simultaneously sense the surface states of the first polishing pad 11 and the second polishing pad 21, the scanning speed of the polishing apparatus may be increased, and the scanning time may be remarkably reduced.

After the waviness or surface roughness of the first polishing pad 11 and the second polishing pad 21 is sensed in a specific arc-shaped portion of the upper plate 10 and the lower plate 20, the upper plate 10 and the lower plate 20 are rotated so that the waviness or surface roughness of the first polishing pad 11 and the second polishing pad 21 is successively sensed in other specific arc-shaped portions of the upper plate 10 and the lower plate 20.

FIG. 4 is a schematic view illustrating a portion of the scanning device according to the embodiment. FIG. 5 is a plan view illustrating portion A of FIG. 4. The guide frame 100 may include a recess 110 and magnets 120. In addition, the moving unit 200 may include a protrusion 210 and a coil 220.

The recess 110 may be formed in the longitudinal direction of the guide frame 100, and the moving unit 200 may be guided by the recess 110 so as to move in the longitudinal direction of the guide frame 100. The magnets 120 may be disposed above and under the recess 110.

The protrusion 210 may be formed so as to be inserted into the recess 110 and may be guided by the recess 110. The coil 220 may be disposed inside the protrusion 210 and may be connected to the cable 510 to receive electric power. Here, direct current may be applied to the coil 220.

The coil 220 and the magnets 120 may constitute a linear motor. That is, as illustrated in FIG. 4, the coil 220 may be disposed to vertically face the magnets 120, which are disposed above and under the recess 110. Meanwhile, as illustrated in FIG. 5, the magnets 120 may be disposed in the longitudinal direction of the guide frame 100 such that opposite N- and S-poles are alternately arranged.

With this configuration, when electric power is applied to the coil 220, the moving unit 200 may move in the longitudinal direction of the guide frame 100 by electromagnetic interaction of the magnets 120 and the coil 220.

That is, thrust force is generated by the interaction of a magnetic flux, which is generated in and around the coil 220 when direct current is applied to the coil 220, and a magnetic flux, which is generated by the magnets 120, and the moving unit 200 including the protrusion 210 may be moved in the longitudinal direction of the guide frame 100 by the thrust force.

As the moving unit 200 moves, the bracket 300 and the sensing unit 400, which are coupled to the moving unit 200, may move in the longitudinal direction of the guide frame 100. At this time, when the direction of the direct current that is applied to the coil 220 is changed, the direction in which the moving unit 200 moves may be changed.

Meanwhile, although the coil 220 has a spring shape in the embodiment, the coil may have any other shape, so long as it enables the generation of thrust force by electromagnetic interaction with the magnets 120.

As illustrated in FIG. 4, each of the first sensor 410 and the second sensor 420 may include a lens unit L for laser emission. The lens unit L provided in the first sensor 410 may emit a laser upward so that the sensing unit 400 may sense the waviness or surface roughness of the first polishing pad 11.

In addition, the lens unit L provided in the second sensor 420 may emit a laser downward so that the sensing unit 400 may sense the waviness or surface roughness of the second polishing pad 21.

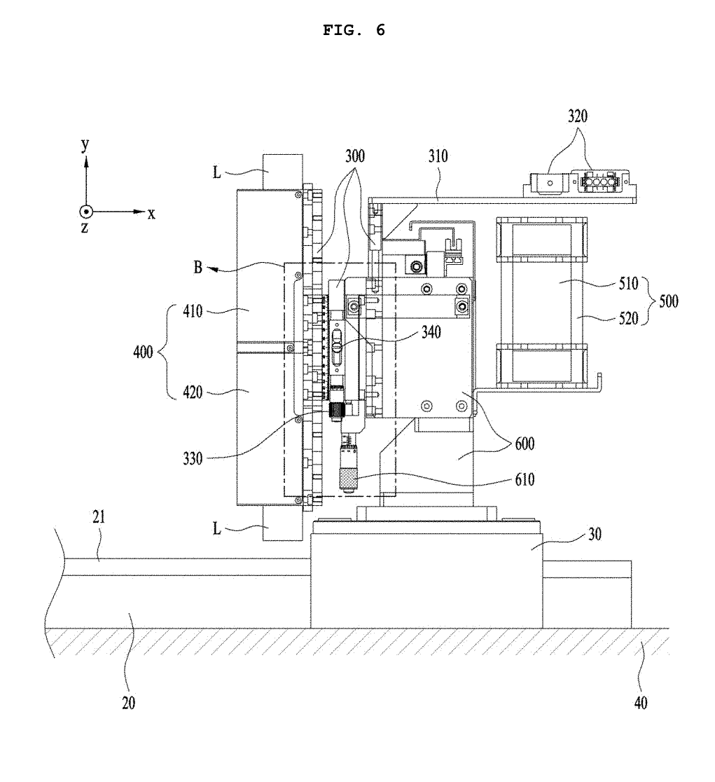

FIG. 6 is a view taken along line Z-Z of FIG. 3. FIG. is an enlarged view illustrating portion B of FIG. 6. Although the bracket 300 has different shapes in FIGS. 4 and 6, it should be noted that the bracket 300 is diagrammatically illustrated in FIG. 4, for the clarity of the disclosure.

As illustrated in FIG. 6, the support stand 30 may be used in order to enable appropriate positional and height adjustment of the guide frame 100. That is, although the scanning device may be disposed on the floor 40, the support stand 30 may be placed on the floor 40, and the support unit 600 of the scanning device may in turn be disposed on the upper surface of the support stand 30 so as to adjust the position and height of the guide frame 100 as appropriate.

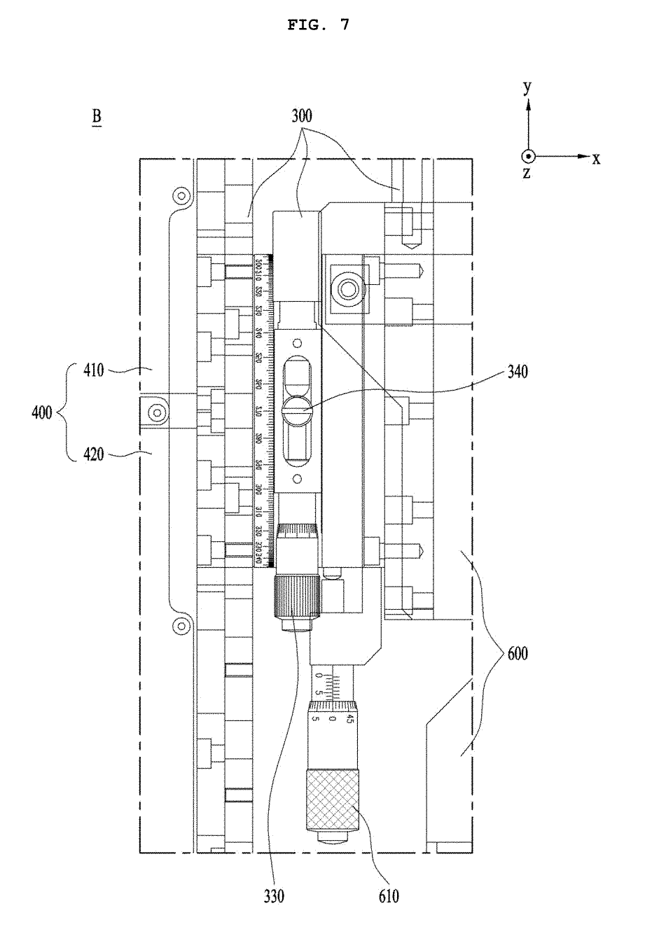

Meanwhile, as illustrated in FIGS. 6 and 7, the scanning device of the embodiment may further include a first adjustment lever 610, a second adjustment lever 330, and a third adjustment lever 340.

The first adjustment lever 610 may be coupled to the support unit 600 and may serve to adjust the vertical height of the guide frame 100. Here, the first adjustment lever 610 may be coupled to each of the pair of support units 600.

The first adjustment lever 610 may adjust the vertical height of the guide frame 100 in such a manner that the guide frame 100 may be moved in the vertical direction, i.e. along the y-axis in FIG. 6, relative to the support unit 600 when the first adjustment lever 610 is rotated.

Meanwhile, because a pair of first adjustment levers 610 is respectively provided on the pair of support units 600, the gradient of the guide frame 100 relative to the upper plate 10 and the lower plate 20 may be adjusted when the respective adjustment levers 610 are appropriately adjusted. That is, the pair of first adjustment levers 610 may be appropriately adjusted so that the guide frame 100 is disposed parallel to the z-axis as illustrated in FIG. 6, or is obliquely disposed relative to the z-axis.

The second adjustment lever 330 may be provided on the bracket 300 and may serve to adjust the vertical height of the sensing unit 400. When the second adjustment lever 330 is rotated, the sensing unit 400 may move in the vertical direction, i.e. along the y-axis in FIG. 6 relative to the bracket 300.

Here, the second adjustment lever 330 may minutely move the sensing unit 400 in the vertical direction. As such, through the adjustment of the second adjustment lever 330, the distances from the lens units L of the sensing unit 400 to the surfaces of the first polishing pad 11 and the second polishing pad 21 may be optimized.

The third adjustment lever 340, as illustrated in FIGS. 6 and 7, may be provided on the bracket 300, and may serve to adjust the angle by which the sensing unit 400 rotates about the axis that is orthogonal to the longitudinal direction of the guide frame 100.

As illustrated in FIG. 6, the third adjustment lever 340 may adjust the angle by which the sensing unit 400 rotates about the axis that is parallel to the x-axis, which is orthogonal to the z-axis, which is parallel to the longitudinal direction of the guide frame 100.

The third adjustment lever 340 may move in the vertical direction, i.e. along the y-axis. Hence, when the third adjustment lever 340 is moved in the vertical direction, the sensing unit 400 may minutely rotate about an axis that is parallel to the x-axis.

Accordingly, when the sensing unit 400 is rotated via the adjustment of the third adjustment lever 340, the distances from the lens units L of the sensing unit 400 to the surfaces of the first polishing pad 11 and the second polishing pad 21 may be optimized.

As described above, as the height or the gradient of the guide frame 100 is adjusted via the first adjustment lever 610, the vertical height of the sensing unit 400 is minutely adjusted via the second adjustment lever 330, and the rotation angle of the sensing unit 400 is adjusted via the third adjustment lever 340, the distances from the lens units L of the sensing unit 400 to the surfaces of the first polishing pad 11 and the second polishing pad 21 may be adjusted.

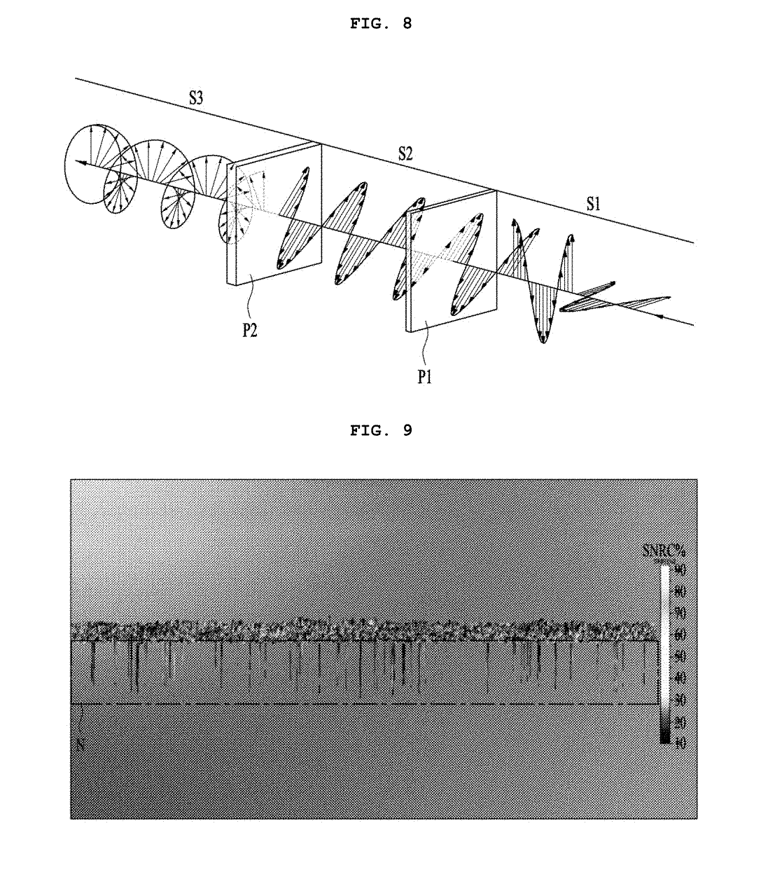

FIG. 8 is a view for explaining variation in the characteristics of light that passes through a polarizer plate P1 and a quarter-wave plate P2 provided in the scanning device according to the embodiment.

The sensing unit 400, i.e. the first sensor 410 and the second sensor 420 may include the polarizer plate P1 and the quarter-wave plate P2. Here, the polarizer plate P1 and the quarter-wave plate P2 may be provided inside the first sensor 410 and the second sensor 420.

In addition, the lens unit L, the polarizer plate P1 and the quarter-wave plate P2 may be sequentially disposed in the optical-axis direction in which a laser is emitted. That is, a laser emitted from a laser generator (not illustrated) may sequentially pass through the polarizer plate P1, the quarter-wave plate P2 and the lens unit L.

Although the laser is not polarized in a section S1 in which the laser emitted from the laser generator reaches the polarizer P1, the laser is linearly polarized in a section S1 in which the laser that has passed through the polarizer plate P1 reaches the quarter-wave plate P2.

The laser is circularly polarized after passing through the quarter-wave plate P2. As illustrated in FIG. 8, the circularly polarized laser has a spiral movement path about the direction in which the laser moves.

With this structure, the laser emitted from the laser generator may become the circularly polarized laser so as to pass through the lens unit L and be directed to the first polishing pad 11 and the second polishing pad 21. The reason why the sensing unit 400 uses the circularly polarized laser is to reduce noise generated in measured data, i.e. data on the waviness or surface roughness of the first polishing pad 11 and the second polishing pad 21.

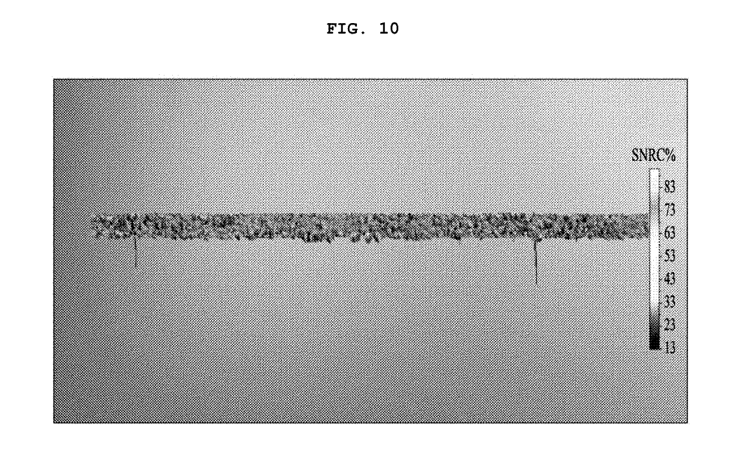

FIG. 9 is a graph for explaining the characteristics of a data signal to be scanned when the scanning device has no quarter-wave plate P2. FIG. 10 is a graph for explaining the characteristics of a data signal to be scanned when the scanning device has a quarter-wave plate P2.

Numerical values marked on the right portion of the graph indicate a signal-to-noise ratio (SNR) and the unit thereof is % Here, when the SNR is recorded over a wide numerical range, this means inaccurate data, i.e. noise N.

As illustrated in FIG. 9, when the sensing unit 400 includes no quarter-wave plate P2 and emits a linearly polarized laser to the first polishing pad 11 or the second polishing pad 21, a large amount of noise N may be generated in a data signal received by the sensing unit 400.

On the other hand, as illustrated in FIG. 10, when the sensing unit 400 includes the quarter-wave plate P2 and emits a circularly polarized laser to the first polishing pad 11 or the second polishing pad 21, it will be appreciated that noise N is remarkably reduced in a data signal received by the sensing unit 400, compared to the result of FIG. 9.

Accordingly, because the measured data may have remarkably reduced noise N when the circularly polarized laser is emitted to the first polishing pad 11 or the second polishing pad 21 through the use of the quarter-wave plate P2, the scanning device may more accurately verify the surface state of the first polishing pad 11 and the second polishing pad 21.

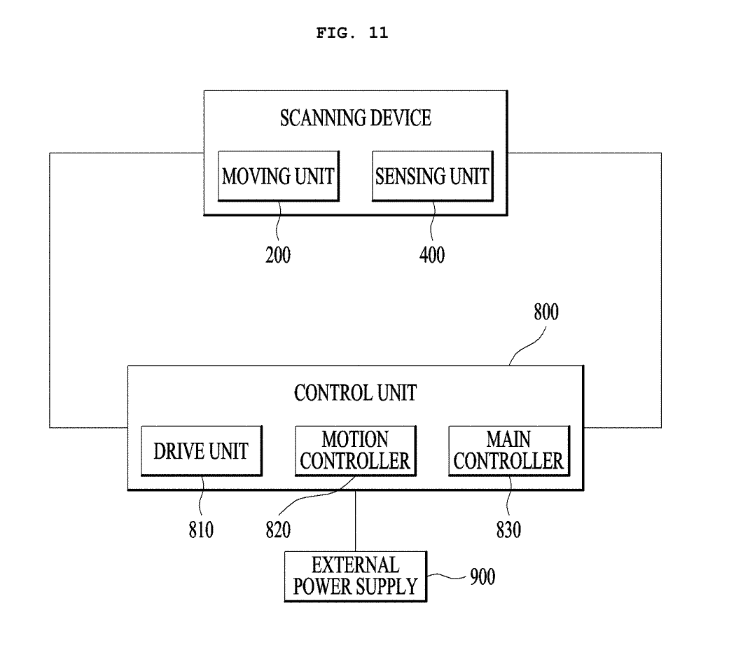

FIG. 11 is a view for explaining a scanning system according to an embodiment. The scanning system may include the scanning device, the control unit 800 and the external power supply 900. The scanning device, as described above, may include, for example, the moving unit 200, the bracket 300, the sensing unit 400, and the support unit 600, and a detailed structure thereof is the same as the above description. The external power supply 900 may be connected to the control unit 800 to perform the supply of electric power.

The control unit 800 may be connected to both the external power supply 900 and the scanning device. In particular, the control unit 800 may be electrically connected to positively operating elements of the scanning device, i.e. the moving unit 200 and the sensing unit 400. Accordingly, the control unit 800 may receive electric power from the external power supply 900 and may again supply the electric power to the moving unit 200 and the sensing unit 400.

The control unit 800 may control operation of the moving unit 200, and may control operation of the sensing unit 400 to thereby receive measured data therefrom. The control unit 800 may include a drive unit 810, a motion controller 820, and the main controller 830.

The drive unit 810 may supply electric power to the moving unit 200 so as to operate the moving unit 200. Here, the drive unit 810 may supply direct current to the moving unit 200. This is because the moving unit 200 is driven by direct current. Accordingly, as needed, the control unit 800 may include, for example, a rectifier that converts alternating current into direct current.

The motion controller 820 may control the operation of the drive unit 810. That is, the motion controller 820 may transmit a signal to the drive unit 810 so as to cause the drive unit 810 to adjust, for example, the movement or stoppage of the moving unit 200, and the movement direction and the movement speed of the moving unit 200.

The main controller 830 may control the motion controller 820. Thus, the main controller 830 may initially transmit an operation signal, and the operation signal may be finally transmitted to the drive unit 810 by way of the motion controller 820.

In addition, the main controller 830 may operate the sensing unit 400, and may receive the measured data from the sensing unit 400, i.e. data on the waviness or surface roughness of the first polishing pad 11 and the second polishing pad 21. The main controller 830 may record the data, or may display the data as, for example, numerical values or images to allow a user to view the data.

In the embodiments, because the scanning device and the scanning system may scan the polishing apparatus in a non-contact manner, little vibration and friction may occur compared to that in a contact manner, and consequently, accurate data on the surface state of the polishing apparatus may be collected.

Although only several embodiments have been described above, various other embodiments are possible. The technical ideas of the embodiments described above may be combined into various forms unless they are incompatible techniques, and thereby new embodiments may be realized.

### INDUSTRIAL APPLICABILITY

In embodiments, because the sensing unit may simultaneously sense the surface states of both a first polishing pad a second polishing pad, the scanning speed of the polishing apparatus may be increased and the scanning time may be remarkably reduced. Therefore, the disclosure has industrial applicability.

1. A scanning device comprising:
a guide frame;
a moving unit configured to move in a longitudinal direction of the guide frame;
a bracket coupled at one side thereof to the moving unit;
a sensing unit coupled to a remaining side of the bracket and configured to sense a surface state of an object disposed in a vertical direction that is orthogonal to the longitudinal direction of the guide frame; and
a pair of support units coupled to opposite sides of the guide frame.

2. The scanning device according to claim 1, wherein the guide frame includes a recess formed in the longitudinal direction thereof and magnets disposed above and under the recess, and
wherein the moving unit includes a protrusion configured to be inserted into the recess and a coil disposed inside the protrusion to receive electric power.

3. The scanning device according to claim 2, wherein the magnets are disposed in the longitudinal direction of the guide frame, and N-poles and S-poles are alternately disposed.

4. The scanning device according to claim 2, wherein the coil is disposed to vertically face the magnets disposed above and under the recess.

5. The scanning device according to claim 1, wherein the guide frame is upwardly and downwardly spaced apart from an upper plate and a lower plate of a wafer polishing apparatus, respectively.

6. The scanning device according to claim 5, wherein the upper plate has a lower surface to which a first polishing pad is attached, and the lower plate has an upper surface to which a second polishing pad is attached.

7. The scanning device according to claim 6, wherein the sensing unit senses a waviness or surface roughness of the first polishing pad and the second polishing pad, attached respectively to the upper plate and the lower plate.

8. The scanning device according to claim 6, wherein the sensing unit includes a laser sensor, and
wherein the sensing unit includes:
a first sensor provided in an upper region thereof and configured to emit a laser to the first polishing pad; and
a second sensor provided in a lower region thereof and configured to emit a laser to the second polishing pad.

9.-11. (canceled)

12. The scanning device according to claim 5, wherein the upper plate and the lower plate have a disc shape and are disposed such that a lower surface of the upper plate and an upper surface of the lower plate face each other, and the guide frame is longitudinally disposed in a circular arc direction of the upper plate and the lower plate.

13. (canceled)

14. The scanning device according to claim 1, further comprising
a first adjustment lever coupled to each of the support units and configured to adjust a vertical height of the guide frame;
a second adjustment lever provided on the bracket and configured to adjust a vertical height of the sensing unit; and
a third adjustment lever provided on the bracket and configured to adjust an angle by which the sensing unit rotates about an axis that is orthogonal to the longitudinal direction of the guide frame.

15. (canceled)

16. (canceled)

17. The scanning device according to claim 1, wherein the bracket includes a bent portion formed by laterally bending an upper portion of the bracket in a direction that is orthogonal to the longitudinal direction of the guide frame, and a connector provided on the bent portion so as to be connected to an external power supply that is configured to apply electric power to the moving unit or the sensing unit.

18. (canceled)

19. A scanning system comprising:
a guide frame;
a moving unit configured to move in a longitudinal direction of the guide frame;
a bracket coupled at one side thereof to the moving unit;
a sensing unit coupled to a remaining side of the bracket and configured to sense a surface state of an object disposed in a vertical direction that is orthogonal to the longitudinal direction of the guide frame;
a pair of support units coupled to opposite sides of the guide frame;
a control unit electrically connected to the moving unit and the sensing unit; and
an external power supply configured to supply electric power to the control unit.

20. The scanning system according to claim 19, wherein the control unit includes:
a drive unit configured to operate the moving unit;
a motion controller configured to control an operation of the drive unit; and
a main controller configured to control the motion controller, to operate the sensing unit, and to receive measured data from the sensing unit.
